(19) United States
(12) Patent Application Publication
(10) Pub. No.: US 2010/0108690 A1
(43) Pub. Date: May 6, 2010

(54) Stainless Steel-Carbon Steel Enamelized Cookware

(75) Inventor: William A. Groll, McMurray, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ALL-CLAD METALCRAFTERS LLC, Canonsburg, PA (US)

(21) Appl. No.: 12/539,847

(22) Filed: Aug. 12, 2009

Related U.S. Application Data
(60) Provisional application No. 61/088,056, filed on Aug. 12, 2008.

(51) Int. Cl. A47J 37/01

(52) U.S. Cl. 220/573.1

(57) ABSTRACT

Cookware made from a composite metal sheet having a stainless steel or titanium layer defining a cooking surface bonded to a low carbon steel layer having a porcelain enamel layer applied thereto and forming an exterior of said cookware. An intermediate layer of copper or nickel may also be bonded between the layers of stainless steel or titanium and the low carbon steel layer.

### CROSS-REFERENCE TO RELATED APPLICATION

This application claims priority to U.S. Provisional Patent Application No. 61/088,056 filed Aug. 12, 2008, which is incorporated by reference herein in its entirety.

### BACKGROUND OF THE INVENTION

1. Field of the Invention

The present invention generally relates to composite cookware and, more particularly, to an improvement in porcelain enameled cookware having improved stain resistance and cleaning attributes over prior cookware of this type.

2. Description of Related Art

Cookware functions best when there is thermal conductivity to spread and retain heat and has a strong, corrosion resistant, non-reactive food preparation surface. Techniques of achieving these ends have been well explored and are most often achieved by the lamination (or bonding) of dissimilar metals. Numerous patents over the past century have described methods of joining metals of higher thermal conductivity, such as aluminum, copper or carbon steel, with metals of lesser conductivity but higher inertness such as various alloys of stainless steel or titanium. For thermal conductivity, aluminum has been widely applied. It is highly conductive, lightweight, has a relatively high latent energy, bonds easily to other metals and is economically affordable. However, aluminum also has a much lower melting point than other conductive metals, which fact makes it impossible to use composite metal arrangements that involve aluminum when applying coatings such as porcelain that require processing temperatures that exceed the melting temperature of aluminum.

Various manufacturers have featured cookware products made from cast iron or low carbon steel and coated inside and out with porcelain enamels. These coatings are decorative and serve as a corrosion protection when applied to steel or cast iron. Porcelain is a fairly inert food preparation surface but is subject to chipping, cracking and staining.

### SUMMARY OF THE INVENTION

It is with the above background in mind that the present invention has been made. The cooking vessel of the present invention comprises a laminated composite construction employing an exterior layer of low carbon steel forming the majority of the thickness of the composite. The interior of the composite defines a food preparation surface made of one of a variety of stainless steels, such as those selected from the 300 or 400 types, or with a layer of titanium or titanium alloy. The two layers of stainless steel (or titanium) and low carbon steel may be directly bonded together or the composite may involve a third intermediate layer of a metal such as copper or nickel to accommodate bonding and add some additional thermal benefits such as conductivity. The third intermediate metal cannot be aluminum, which melts at a temperature below the application temperature of the porcelain enamel exterior.

It is not the intention of this invention to claim the composition of the bond but, rather, the creation of cookware with a porcelain enamel exterior and a bare metal interior cook surface of, for example, stainless steel or titanium.

In a presently preferred embodiment, a metal composite is created using low carbon steel, for example, having a thickness 0.060″, a bonding layer of copper at 0.004″ thickness, and a stainless layer of 0.010″ in thickness. These metals are bonded by one of several well-known techniques such as by cold roll reduction. The resulting strip of composite roll bonded metal is annealed to restore mechanical ductility after the roll bonding process. The resulting annealed metal is then deep drawn by known techniques into the shape of a round saucepan. The pan is drawn with the stainless layer on the inside (cook surface) and the low carbon steel layer on the outside of the pan with the copper layer intermediate the two. The rim of the pan is rolled over to wrap a small margin of interior stainless steel around the upper rim of the pot, thus creating a protective, non-corrosive boundary covering the low carbon steel to prevent rusting. This is a well-known practice that has been done for many years by companies such as West Bend and Regal Ware. The exterior of the pan is then coated with a high temperature porcelain enamel and fired. The stainless steel interior of the pan is then polished to a high luster by well-known polishing techniques.

The resulting pan has the thermal conductivity of carbon steel and thermally behaves in a manner similar to enameled cast iron or enameled carbon steel. It has a cosmetic exterior appearance that is a glossy porcelain enamel, possibly featuring vivid colors. It has a polished stainless steel interior, thus avoiding the inherent downfalls of chipping, cracking or staining of the interior food preparation surfaces that are formed with prior porcelain interior coated cookware.

An additional advantage of employing this particular composite of material (without aluminum) is the ability to make attachments to the exterior layer of low carbon steel by welding. Features such as handles or handle brackets can be added, then coated during the enameling process.

The enameling process must start with low carbon steel in order to be successful. Low carbon steel is more conductive and far less costly than stainless steel. For these reasons, the thickness of the carbon steel relative to the thickness of the stainless steel should be maximized within manufacturing and weight constraints. Factors such as draw forming, spinning or polishing and overall weight of the vessel need to be taken into consideration when selecting the carbon steel layer thicknesses. The exterior layer of carbon steel must be selected from a group of carbon controlled steels that are compatible with well-known porcelain coating techniques. The thickness of the outer layer should be maximized within practical weight limits for a cooking vessel. The interior layer of stainless alloy or titanium or titanium alloy should be selected from grades (ferritic or austenitic stainless steels) that are popularly accepted as food grade preparation alloys. Titanium is acceptable as a food preparation surface but is much more difficult to bond and fabricate into cookware shapes but it still falls within the scope of the present invention.

### BRIEF DESCRIPTION OF THE DRAWINGS

FIG. 1 is a cross-sectional view of a composite metal sheet suitable for making the cookware of the present invention;

FIG. 2 is a cross-sectional view of a cooking vessel of the present invention in the shape of a stock pot; and

FIG. 3 is a cooking vessel of the present invention in the shape of a wok.

### DETAILED DESCRIPTION OF THE INVENTION

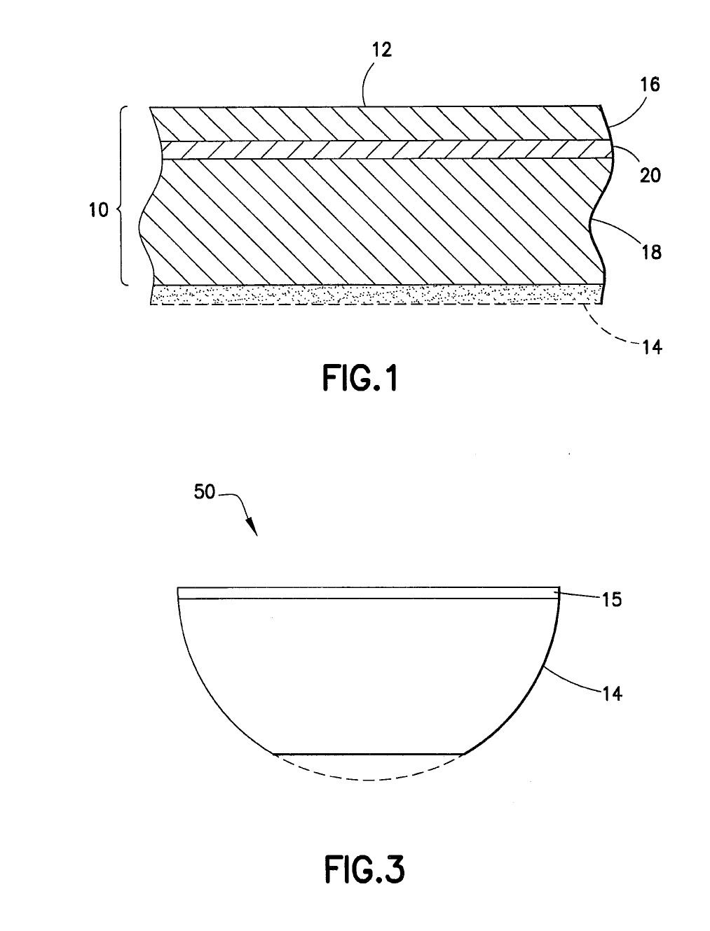

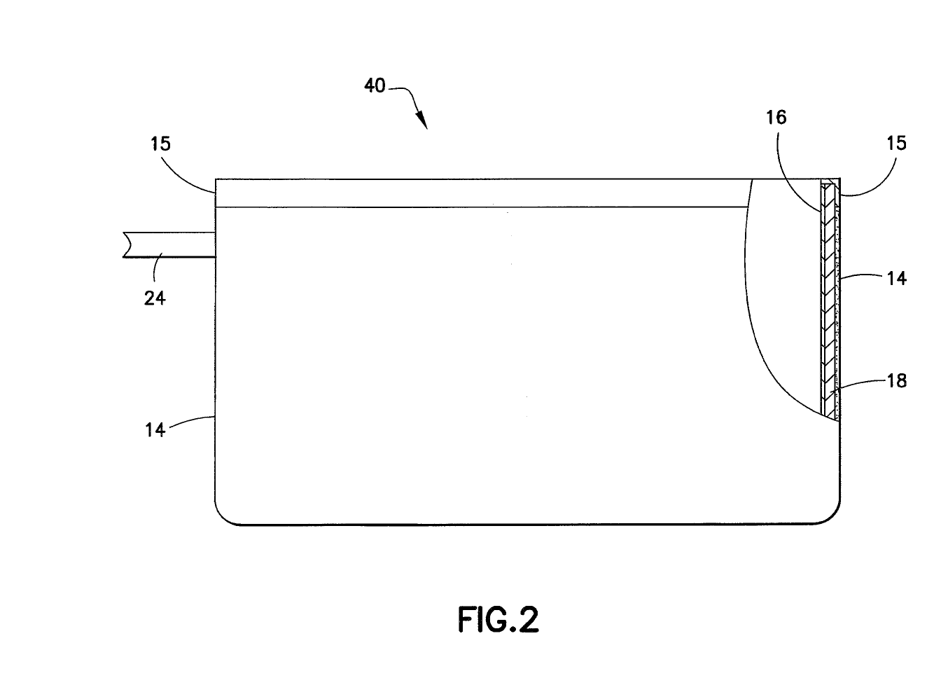

A composite metal sheet 10 depicted in FIG. 1 is used in the manufacture of a cookware vessel 40 shown in FIG. 2. The composite metal sheet 10 includes a layer 16 of stainless steel or titanium that is roll or impact bonded to a thicker layer 18 of low carbon steel with an intermediate layer 20 of copper or nickel therebetween. In the composite metal sheet 10, the low carbon steel layer 18 occupies the greatest thickness, for example, about 94% thereof, while the stainless steel or titanium of layer 16 represents about 5% of the overall thickness and the intermediate layer 2 of copper or nickel occupies about 1%. Of course, these relative thicknesses can vary within reasonable ranges. For example, the low carbon steel layer can be about 90-96% of the overall composite thickness while the stainless steel can be about 3-8% and the copper 1-2%.

A presently preferred embodiment of the invention is made from a composite metal sheet 10 consisting of a stainless steel layer 16 having a thickness of about 0.010 inch bonded to a low carbon steel layer 18 having a thickness of about 0.060 inch with a layer 20 of copper having a thickness of about 0.004 inch intermediate the carbon steel and stainless steel layers. The composite metal sheet 10 may be formed by cold rolling reduction, followed by annealing to permit subsequent deep drawing or other forming to a desired cookware shape.

The formed cookware 40 in the form of a pot or pan may be in the shape of a round saucepan or stock pot as shown in FIG. 2 or the like. The pan or pot 40 is drawn with the stainless steel layer 16 forming the cook surface 12 on the inside of the cookware and the carbon steel layer 18 facing the outside 14 of the pan or pot 40. The stainless steel layer 16 preferably extends above the open top of the pan 40 after drawing and is rolled over to form a stainless steel rim 15 covering the top edge of the carbon steel layer 18. The balance of the carbon steel 18 forming the exterior of the cookware 40 is then coated with a high temperature porcelain enamel layer 22. Handles 24 or handle brackets (not shown) may be welded or otherwise attached to the carbon steel layer 18 prior to enameling. The stainless steel layer 16 is then preferably polished to a high luster along the cook surface 12 to improve the stick resistance and to enhance the cosmetic appearance of the cookware 40.

The cooking vessel 40 configuration can be in the shape of a saucepan as shown in FIG. 2 or any other desired shape such as a fry pan, stock pot, Dutch oven or other shape, such as the wok 50 depicted in FIG. 3. Conventional handles may be added. The wok 50 may have a flat bottom as shown in phantom lines in FIG. 5.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. Cookware made from a composite metal sheet, the cookware comprising one of a stainless steel or titanium layer defining a cooking surface bonded to a low carbon steel layer having a porcelain enamel layer applied thereto and defining an exterior surface of said cookware.

2. The cookware of claim 1 including a layer of copper or nickel intermediate said stainless steel or titanium layer and low carbon steel layers.

3. The cookware of claim 2 wherein the layer of low carbon steel occupies between about 90-96% of a thickness of the composite metal sheet and the layer of stainless steel or titanium occupies about 3-8% of said thickness and the layer of copper or nickel occupies about 1-2% of said thickness.

4. The cookware of claim 1 including a rolled-over rim of stainless steel or titanium covering a top edge of said low carbon steel layer.

5. Cookware made from a composite metal sheet comprising a stainless steel layer defining a cooking surface and a low carbon steel layer having a porcelain enameled surface forming an exterior of said cookware.

6. The cookware of claim 5 wherein the composite metal sheet includes an intermediate layer of copper or nickel.

7. The cookware of claim 5 wherein the stainless steel layer has a polished surface.

8. The cookware of claim 1 wherein the layer of low carbon steel occupies about 94% of the thickness of the composite metal and the layer of stainless steel or titanium occupies about 5% of said thickness and said layer of copper or nickel occupies about 1% of said thickness.

9. Cookware made from a composite metal sheet comprising a stainless steel layer defining an interior cooking surface and a low carbon steel layer having a porcelain enamel layer applied to the low carbon steel layer defining an exterior surface of said cookware.

10. The cookware of claim 9 wherein the stainless steel layer has a polished surface.
